(19) United States
(12) Patent Application Publication
(10) Pub. No.: US 2012/0221335 A1
(43) Pub. Date: Aug. 30, 2012

(54) METHOD AND APPARATUS FOR CREATING VOICE TAG

(75) Inventors: Rui Zhao, Beijing (CN); Lei He, Beijing (CN)

(73) Assignee: Kabushiki Kaisha Toshiba

(21) Appl. No.: 13/404,186

(22) Filed: Feb. 24, 2012

(30) Foreign Application Priority Data
Feb. 25, 2011 (CN) 201110046560.7

(51) Int. Cl. G10L 17/00

(52) U.S. Cl. 704/250; 704/E17.001

(57) ABSTRACT

According to one embodiment, the method may include constructing a first voice tag for registration speech based on Hidden Markov acoustic model (HMM), constructing a second voice tag for the registration speech based on template matching, and combining the first voice tag and the second voice tag to construct voice tag of the registration speech.

### CROSS-REFERENCE TO RELATED APPLICATIONS

This application is based upon and claims the benefit of priority from prior Chinese Patent Application No. 201110046560. 7, filed Feb. 25, 2011, the entire contents of which are incorporated herein by reference.

### FIELD

Embodiments described herein relate generally to speech recognition technology, and more particularly, to creation of voice tag.

### BACKGROUND

Speech recognition technology is also called as automatic speech recognition ASR, and it aims at converting word contents in speech of human being into computer readable input, such as keys, binary codes or character sequence and so on. Hereby, machine may convert the speech signal into corresponding text or command by the processes of speech recognition and comprehension. With development of science and technology in the information technology field, it is expected that speech recognition technology will come into various fields like industry, appliance, communication, auto electronics, medical, homework, consuming electronic product and so on in a few years. In the information technology, the important part of human-machine interface includes speech recognition, which integrates speech synthesis technology so as to allow people to operate by speech commands without keyboard. This reduces size of apparatus significantly, increases convenience for people and facilitates especially in a case that manual operation is inconvenient such as driving and promotes efficient interaction. Application of speech recognition technology has become a rising high technology industry with competitive power.

Application of speech recognition technology may include speech dialing, speech navigating, indoor device controlling, speech document searching, data entry by hearing and writing and so on. Voice tag is also a specific application of speech recognition technology, and now is widely used in embedded system. For example, in telephone equipped with speech recognition, contact is dialed or application is opened by voice tag, or voice tag is used for speech information query system for querying information and so on.

Generally, construction procedure of voice tag is as follows: user inputs registration speech into system, the system converts it into tag representative of pronunciation of the speech, and a word item represented by the pronunciation tag is added to recognition network. The recognition network defines sentences that can be recognized. This procedure is also called as registration procedure. For example, when user speaks out “LiSi”(“ [symbol] ”) during registration procedure, the system may construct a tag to represent the pronunciation of the voice, and associate the voice tag to application or information to be represented, such as telephone number.

During recognition procedure, the speech recognition recognizes the testing speech based on recognition network including voice tag item to determine its content.

In the art, a general method of constructing voice tag may include voice tag method based on template matching and voice tag method based on Hidden Markov Model for example. In the method based on template matching, one or more templates are extracted for registration speech as voice tag of the registration speech during the registration procedure, while dynamic time warping (DTW) algorithm may be applied to match testing speech and template tag during the recognition procedure. The easiest way is to use feature of the registration speech as template, feature of the testing speech is compared with feature of the registration speech while testing, and the closest template of them is selected as recognition result.

For example, the feature of the registration speech is X^{r}={x^{r}₁, x^{r}₂, . . . , x^{r}_{T1},}, T1 is total number of the registration speech frames, X^{r} may be used as template of the registration speech, i.e., voice tag. The feature of the testing speech is X^{t}={x^{t}₁, x^{t}₂, . . . , x^{t}_{T2},}, T2 is total number of the testing speech frames. The testing procedure is a matching procedure of X^{r}and X^{t}. Generally, dynamic time warping algorithm is applied, which is a general algorithm for measuring similarity between two sequences with different lengths and will not be detailed for brevity.

The method based on template matching can better describe time correlation of speech. However, the method based on template matching generally needs larger space to store template, and isn't robust to the mismatch of the registration speech and testing speech.

Recently, as Hidden Markov Model (HMM) based on phoneme (or other speech unit, such as syllable) is widely used in speech recognition, phoneme sequence as voice tag has become main voice tag method. Markov Model is a finite state auto-machine in the discrete time domain, Hidden Markov Model means that internal state of this Markov Model is invisible from outside, only output values of each time can be seen from outside. HMM can efficiently depict dynamic change feature of speech in time, and achieve matching between feature sequence of speech signal and acoustic unit representative of speech (such as phoneme, syllable and so on). Further, sophisticated train and recognition algorithm of HMM establishes a base for application of it in speech recognition. In general speech recognition system, one phoneme is a HMM including N states, one word (or syllable) is a HMM concatenated by HMM of multiple phonemes constituting the word, while the whole model of continual speech recognition is HMM combined by word and mute, and its output of state is acoustic feature. In this method, phoneme sequence is obtained as voice tag of registration speech by phoneme recognition of the registration speech.

Voice tag method based on HMM uses phoneme (or other speech unit) sequence as voice tag, and occupies less memory than template tag. On the other hand, word item with voice tag of phoneme sequence is easier to integrate with phonetically transcribed word item of non-voice tag to construct new recognition network. This is helpful to increase allowable number of word items of voice tag system.

However, voice tag method of phoneme sequence has also some disadvantages: firstly, phoneme recognition errors are unavoidable, which makes voice tag of phoneme sequence to represent pronunciation of registration speech inadequately so as to cause recognition errors. Further, output probability distribution of HMM in respective states is independent mutually, which isn't consistent with continuation of speech parameter vector over time. Thus, there isn't correlation among these states in HMM, which makes it can not describe time correlation of speech better.

### BRIEF DESCRIPTION OF THE DRAWINGS

FIG. 1 illustrates a flow chart of the method according to exemplary embodiment of the invention;

FIG. 2 illustrates registration flow chart of voice tag method based on HMM in the art;

FIG. 3 illustrates phoneme recognition network that is applied into the method in FIG. 2;

FIG. 4 illustrates a flow chart of the method of constructing speech template based on template matching as shown in FIG. 1;

FIGS. 5A and 5B illustrates voice tag constructed by combining first voice tag and second voice tag according to the exemplary embodiment of the invention;

FIGS. 6A and 6B illustrates two alternative approaches of combining first voice tag and second voice tag according to the method of the embodiment of the invention; and

FIG. 7 is block diagram of an apparatus for creating registration voice tag according to the exemplary embodiment of the invention.

### DETAILED DESCRIPTION

In general, according to one embodiment, a method for creating voice tag is provided, which may comprise: constructing a first voice tag for registration speech based on Hidden Markov acoustic model, wherein the first voice tag is associated with specific state; constructing a second voice tag for the registration speech based on template matching; and combining the first voice tag and the second voice tag to construct voice tag of the registration speech.

Below, the embodiments of the invention will be described in detail with reference to drawings.

Generally, the embodiments of the invention relates to a method and system for creating voice tag in electronic device (such as telephone system, mobile terminal, on-board vehicle tool and/or the like). The basis principle is to construct voice tag for registration speech by integrating statistical method of HMM and template matching method. In this principle, in order to integrate both of them efficiently, during template extraction, template is extracted for period corresponding to each HMM state (but not each frame) of registration speech, the template is represented by a Gaussian distribution (or Gaussian mixture model). During integrating both of them, for each state period of the registration, the template representation and the HMM representation are integrated into a new state. Then, new phoneme sequence is formed by linking the new states as final voice tag of the registration speech. In the embodiment of the invention, speech unit may also be other unit than phoneme, such as syllable and the like. For simplicity, only phoneme is illustrated as speech unit for processing. However, those skilled in the art should understand that the embodiment of the invention shall not be limited thereto.

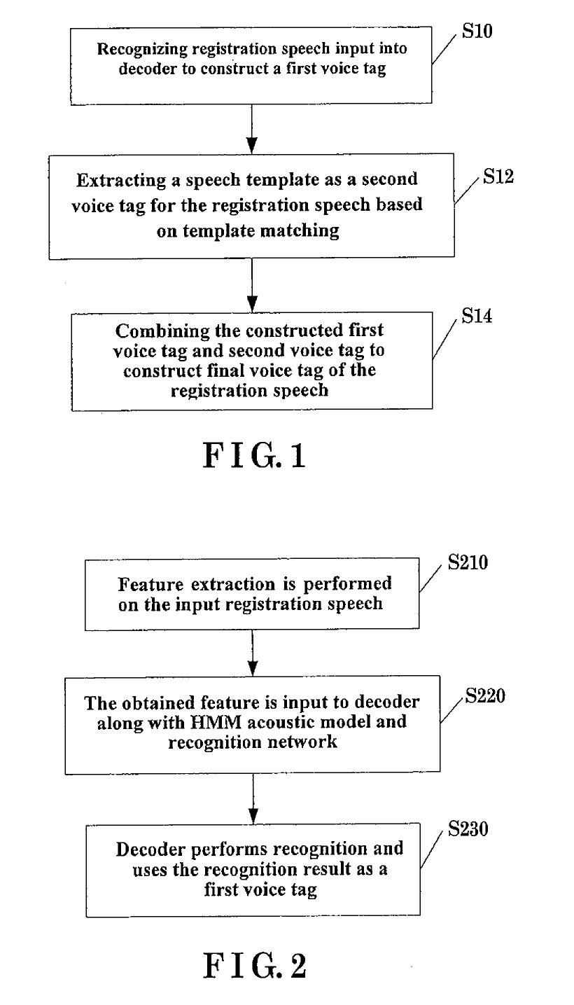

FIG. 1 illustrates a flow chart of the method according to exemplary embodiment of the invention. In step S10, recognizing registration speech input to decoder, in which acoustic model is HMM, recognition network is loop network of phoneme (or other speech unit). The recognition result is phoneme (or other speech unit) sequence. The phoneme sequence is taken as the voice tag in the voice tag method based on HMM, called as first voice tag in the embodiment of the invention. After the first voice tag of the registration speech is obtained, in step S12, extracting speech template for the registration speech based on template matching idea as a second voice tag of the registration speech. Finally, the constructed first voice tag and second voice tag are combined to construct final voice tag of the registration speech (step S13).

### I. Construction of First Voice Tag

As described, the first voice tag may be obtained by performing recognition based on HMM for registration speech, as shown in FIG. 2.

In step S210, feature extraction is performed on the input registration speech (assume that sampling, A/D converting and other preprocessing has been done). Simply, feature extraction includes dividing the speech into frames and extracting a D-dimension feature for each frame. Common feature may be Mel frequency cepstral coefficient (MFCC) and perceptual liner prediction (PLP) parameter and so on. Feature of t-th frame is set as X^{t}={c₁^{t}, c₂^{t}, . . . , c_{D}^{t}}, then feature of the whole sentence is X={x¹, x², . . . , x^{T}}, T is the total number of frames of the speech.

In step S220, after feature is obtained, the feature is input to decoder along with HMM acoustic model (AM) trained by train data and recognition network for recognition.

In the embodiment of the invention, acoustic model may use first order HMM commonly used in speech recognition, the mathematic expression of which is as follows:

$$P ( X / W ) = {\sum }_{S ∈ \{ {S}_{W} \}} p ( {s}_{1} ) p ( {x}_{1} \vert {s}_{1} ) {\prod }_{t = 2}^{T} p ( {x}_{t} \vert {s}_{t} ) p ( {s}_{t} \vert {s}_{t - 1} ) \qquad ( 1 )$$

Wherein, X={x₁ . . . x_{T}} is feature sequence of observing speech, S={s₁ . . . s_{T}} is state sequence, sₜ is state corresponding to the t-th frame speech, W is word sequence, {S_{W}} is the set of state sequences corresponding to word sequence Wₜ p(xₜ|sₜ) is state output probability in HMM, p(sₜ|sₜ₋₁) is state transfer probability.

As shown in equation (2), the output probability of state s may be expressed by Gaussian mixture model (GMM). Gaussian mixture model GMM is a common statistical model in speech signal process, and the basic theoretical premise of this model is that any distribution may be approximated by weighted average of these Gaussian mixtures in any accuracy only if the number of Gaussian mixtures is many enough.

$$p ( x \vert s ) = {\sum }_{m = 1}^{M} {α}_{m} N ( {μ}_{sm} , {Σ}_{sm} ) \qquad ( 2 )$$

Wherein,

$${\sum }_{m = 1}^{M} {α}_{m} = 1 ,$$

μₛₘ is mean value of m-th Gaussian distribution of state s, Σₛₘ is variance of m-th Gaussian distribution of state s, M is number of Gaussian.

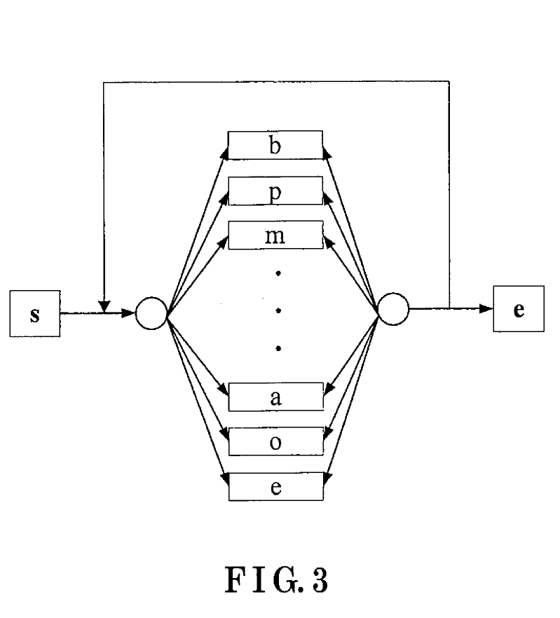

In the embodiment of the invention, for those skilled in the art, HMM model may be predefined by applying train algorithm into the obtained speech feature before voice tag is constructed. In the embodiment of the invention, recognition network may be phoneme recognition network as shown in FIG. 3. As described, in HMM acoustic model, each phoneme (or other speech unit, such as syllable, consonant/vowel in Chinese and so on) may be expressed by HMM. The recognition network as shown in FIG. 3 is free loop of all phonemes in Chinese (b, p, m . . . a, o, e), wherein s is initial state, e is final state.

Those skilled in the art can appreciate that, the recognition network may be different dependent on the applied language, the above recognition network is only for illustration, the recognition network in the embodiment of the invention should not be limited thereto. For example, speech unit of recognition network may be syllable, and the recognition result based on HMM is syllable sequence.

In the embodiment of the invention, in step S230, decoder selects path best matched with the input speech feature from the recognition network as recognition result, and the recognition result is used as voice tag of the registration speech. In the embodiment of the invention, the voice tag is used a first voice tag of the registration speech.

Decoder is one of cores in the speech recognition system, and its task is to find word string that can output the signal in the most probability for the input signal based on acoustic, language model and dictionary. The basis problem of statistical speech recognition is, while input signal or feature sequence is given, to find character string (word sequence) to make its probability the most in a case that feature X of speech is given, and the mathematic model is expressed as follows:

$${W}^{*} = {argmax}_{W} P ( W \vert X ) \qquad ( 3 )$$

It can be further expressed as

$${W}^{*} = {argmax}_{W} P ( W \vert X ) = {argmax}_{W} P ( X \vert W ) P ( W ) / P ( X ) \qquad ( 4 )$$

Wherein, P(W) is language model, P(X) is prior probability of feature. Generally, P(X) is uniform distribution, thus the recognition model can be simplified as:

$${W}^{*} = {argmax}_{W} P ( X \vert W ) P ( W ) \qquad ( 5 )$$

If language model isn't taken into account, it can be further simplified as:

$${W}^{*} = {argmax}_{W} P ( X \vert W ) \qquad ( 6 )$$

Wherein, P(X|W) is calculated by equation (1).

In the embodiment of the invention, phoneme sequence output by decode is used as first voice tag of the registration speech, and each phoneme includes several states in HMM, i.e., phoneme is associated with several states of the HMM. Thus, the phoneme sequence is associated with state sequence formed by several states of each phoneme, and the phoneme sequence can be equally expressed as the state sequence {s1, s2, . . . ,sn}, wherein n is total number of states. For example, number of phonemes in recognition result is p, number of states in each phoneme is q, and thus the total number of states n is p*q.

In order to explain the operation of the embodiment of the invention clearly, the following examples can be taken.

Assume that the pronunciation of registration speech is: LiSi (“ [symbol] ” in Chinese), it is spelled into li si.

Feature is extracted for the registration speech and the feature is input into decoder based on HMM acoustic model, and it is assumed that the phoneme sequence outputted after recognition is {l, i, s, i}. Generally, number of states of HMM may be set as 3-10, herein as 3 for simplicity, and thus each phoneme includes 3 HMM states, and the above phoneme sequence can be equally expressed as state sequence {s1, s2, . . . , s12}. Then, the above phoneme sequence or state sequence may be used as first voice tag of registration speech.

### II. Construction of Second Voice Tag

Second voice tag can be constructed by splitting the registration speech in time based on state associated with the first voice tag; extracting template for speech in each state period; and combining template for each state period to form template sequence as the second voice tag.

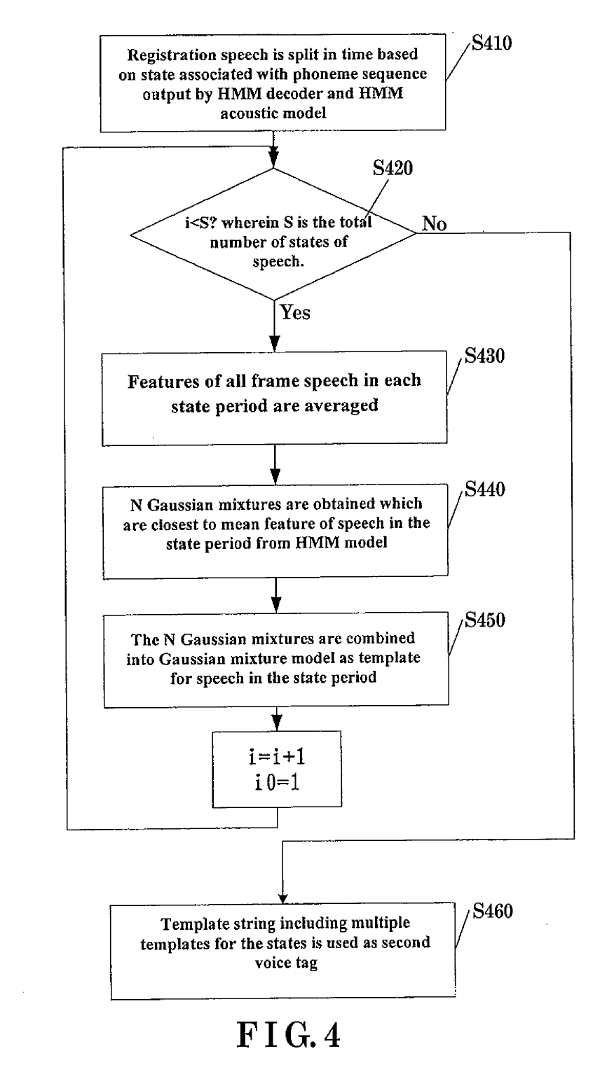

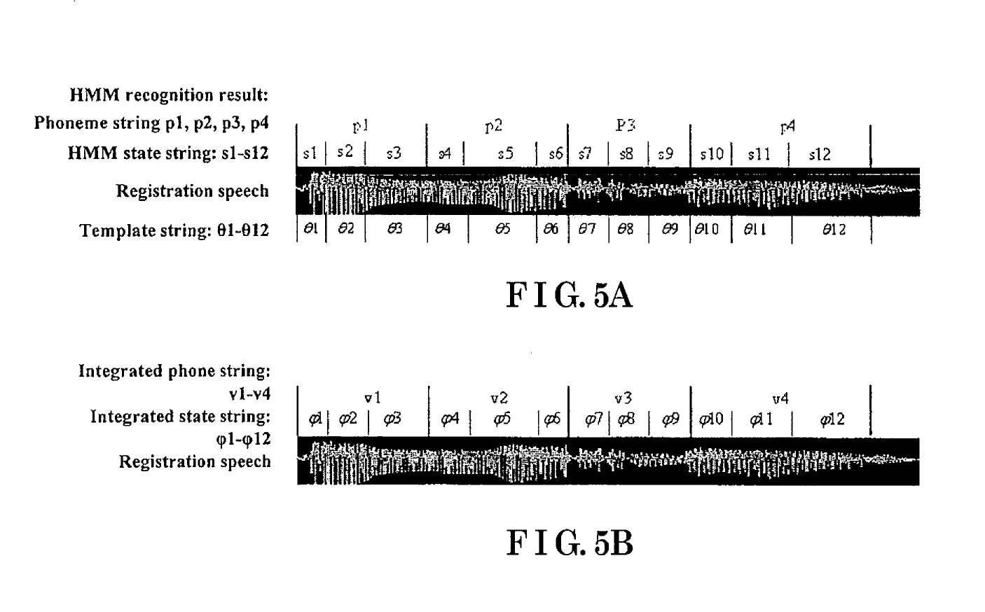

FIG. 4 illustrates a flow chart of the method of constructing second voice tag based on template matching according to embodiment of the invention. As shown in FIG. 4, in step S410, the registration speech is split in time based on state associated with the phoneme sequence in a case that phoneme sequence and HMM acoustic model output by HMM are given. It can be concluded that that part of the speech belongs to a certain state, for example, speech data from t_{b}^{si}-th to tₑ^{si}-th frames belong to state si, wherein i=1, 2, . . . , n, n is total number of states, t_{b}^{s1}1, tₑ^{sn}T1, t_{b}^{s(i+1)}tₑ^{si}+1. T1 is number of frames of the registration speech. As shown in FIG. 5A, short line in FIG. 5A shows state period corresponding to specific state constructed by splitting registration speech.

In the embodiment of the invention, in step S420, operation of extracting template is performed for speech in each state period. For example, steps S430-S450 are all performed for speech in each state period; and step S460 is performed after each state period is finished.

Firstly, in step S430, features of all frame speech in this period are averaged to obtain average feature xₘ^{si}, and its mathematic expression is as follows:

$${x}_{m}^{si} = \frac{1}{{t}_{e}^{si} - {t}_{b}^{si} + 1} {\sum }_{t = {t}_{b}^{si}}^{{t}_{e}^{si}} {x}_{t} \qquad ( 7 )$$

Thereafter, in step S440, in all Gaussian mixtures of HMM, N Gaussian mixtures are selected which are closest to average feature xₘ^{si} of speech in the state period. As shown, this distance is calculated by likelihood score mathematically.

In the embodiment of the invention, for average feature xₘ^{si} of each state period, its likelihood scores relative to all Gaussian mixtures gₖ (k=1, 2, . . . , K) in HMM AM are calculated, wherein K is the number of all Gaussian mixtures in HMM AM. The likelihood score of the average feature xₘ^{si} relative to Gaussian mixtures gₖ is calculated by the following equation:

$$l ( {x}_{m}^{si} , {g}_{k} ) = log ( P ( {x}_{m}^{si} \vert {g}_{k} ) ) = - \frac{2}{D} log ( 2 π ) - \frac{1}{2} log \vert {Σ}_{{g}_{k}} \vert - \frac{1}{2} {( {x}_{m}^{si} - {μ}_{{g}_{k}} )}^{T} {Σ}_{{g}_{k}}^{- 1} ( {x}_{m}^{si} - {μ}_{{g}_{k}} ) \qquad ( 8 )$$

Wherein, μ_{g}_{ₖ} is mean value of Gaussian distribution gₖ, Σ_{g}_{ₖ} is variance of Gaussian distribution gₖ.

Then, top N Gaussian mixtures which likelihood score is highest are set as gᵢ₁, gᵢ₁, . . . , g_{iN}.

Finally, in step S450, certain weights are given to these multiple Gaussian mixtures and the N Gaussian mixtures are combined into Gaussian mixture model θᵢ. This Gaussian mixture model may be used as template of speech in the state period.

Probability of feature x conditioned on GMM model θᵢ is:

$$p ( x \vert {θ}_{i} ) = {\sum }_{n = 1}^{N} {β}_{n} N ( {μ}_{{g}_{in}} , {Σ}_{{g}_{in}} ) \qquad ( 9 )$$

Wherein

$${\sum }_{n = 1}^{N} {β}_{n} = 1 ,$$

in ∈{1, 2, . . . , K}, n=1, 2, . . . , N.

In the embodiment of the invention, in step S460, template sequence including templates for multiple states is used as second voice tag. As described, GMM mode θᵢ is used as template of speech in the i-th state period, template of the whole sentence speech is {θ₁, θ₂, . . . , θₙ}, n is total number of states. Template sequence {θ_{1, θ}₂, . . . , θₙ} is second voice tag of registration speech.

Alternatively, in the embodiment of the invention, template of speech in specific state period can also be constructed in the following manner, such as, one Gaussian distribution is constructed by setting speech mean feature in the state period as mean value and unit matrix as variance matrix (as well as other suitable method of setting variance), and this Gaussian distribution is used as template of speech in the state period in the registration speech.

Compared with the traditional approach of template extraction, the method of the embodiment of the invention has the following advantages:

(1) Template is extracted for each state period, but not each frame, which saves template storage space.

(2) In the embodiment of the invention, the constructed template for each state period is a GMM model or a Gaussian distribution, but not feature, which is suitable to be combined with the voice tag based on HMM.

(3) As to GMM model, all of its Gaussian mixtures come from HMM acoustic model, which further saves storage space.

### III. Combining the Constructed First Voice Tag And Second Voice Tag To Construct Final Voice Tag of the Registration Speech

In the embodiment of the invention, while the first voice tag and second voice tag are combined, state associated with the first voice tag and template of the state period corresponding to the state may be combined to construct new states; and the new states are combined to form voice tag of the registration speech. Preferably, transfer probability among states, contained in the voice tag, for a speech unit may be the same as transfer probability among states contained in the first voice tag.

FIG. 5A illustrates the first voice tag and second voice tag constructed for registration speech according to the exemplary embodiment of the invention. As shown in FIG. 5A, as to a certain registration speech, recognition result based on HMM acoustic model is phoneme sequence {p1, p2, p3, p4}, which is first voice tag, and then {s1, s2, . . . s12} is state sequence associated with first voice tag. Template sequence is obtained, such as {θ₁, θ₂, . . . , θ₁₂}, by splitting the registration speech in time based on state associated with the first voice tag and extracting template for speech in each state period, which is second voice tag.

As shown in FIG. 5B, while the first voice tag and second voice tag are combined, state si of first voice tag and template θi of second voice tag are combined, and new state φi is constructed (i.e. the integrated state) such as {φ₁, φ₂, . . . , φ₁₂}. For period of each phoneme (as shown by long line in the Figure), new states in the period are connected to construct new phoneme vi (i.e. the integrated phoneme). New phoneme is still modeled by HMM, while transfer probability among states in new phoneme (or other pronunciation unit) may be the same as transfer probability among states in original phoneme pi (or other pronunciation unit). In the embodiment of the invention, new phonemes are combined to form new phoneme sequence (i.e. the integrated phoneme string), and new phoneme sequence of registration speech may be used as voice tag of final registration speech.

In the embodiment of the invention, Since state sᵢ of first voice tag and second tag sequence θᵢ are both described by Gaussian mixture model (as shown in equations (2) and (9)) or Gaussian distribution, the combination of them may be achieved by combining their Gaussian mixtures.

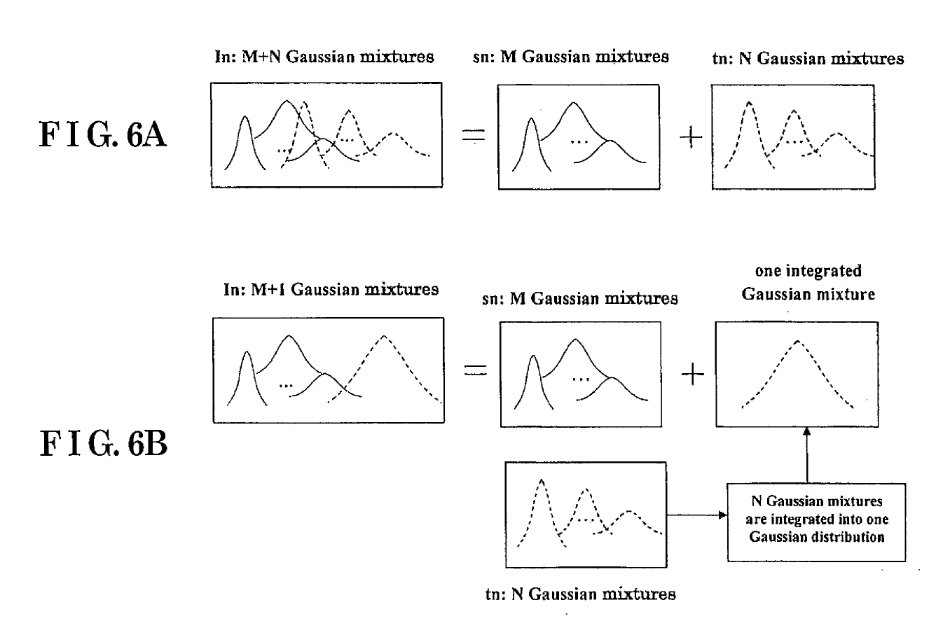

FIG. 6 illustrates two alternative approaches of combining state sᵢ first voice tag and second voice tag θᵢ according to the method of the embodiment of the invention.

In the embodiment of the invention, construction of new state φi may be implemented by taking union set of Gaussian mixtures contained in template of the specific state period and Gaussian mixtures contained in the state of the first voice tag as Gaussian mixtures contained in the new states.

In the embodiment of the invention, as shown in FIG. 6A, union set of Gaussian mixtures of θi (for example, N mixtures as shown by dashed line) and Gaussian mixtures of sᵢ (for example, M mixtures as shown by solid line) are taken as Gaussian mixtures of new state φi (for example, M+N).

At this time, probability of feature x conditioned on the new state φi is:

$$p ( x \vert {ϕ}_{i} ) = {\sum }_{n = 1}^{N} {χ}_{n} N ( {μ}_{{g}_{in}} , {Σ}_{{g}_{in}} ) + {\sum }_{m = 1}^{M} {χ}_{N + m} N ( {μ}_{{s}_{im}} , {Σ}_{{s}_{im}} ) \qquad ( 10 )$$

Wherein

$${\sum }_{n = 1}^{N + M} {χ}_{n} = 1 ,$$

μₛ_{ᵢₘ} is mean value of m-th Gaussian distribution of state sᵢ, Σₛ_{ᵢₘ} is variance of m-th Gaussian distribution of state sᵢ.

Alternatively, in the embodiment of the invention, construction of new state φi may be implemented by merging Gaussian mixtures of the template of the state period into one Gaussian mixture; and combining the Gaussian mixture and Gaussian mixtures of states of the first voice tag as Gaussian mixtures contained in the new states.

In the embodiment of the invention, as shown in FIG. 6B, firstly, N Gaussian mixtures of θᵢ (as shown by dashed line) are combined into one Gaussian distribution N(μ_{θ}_{ᵢ}, Σ_{θ}_{ᵢ}), then it is combined with Gaussian mixtures (M mixtures as shown by solid line) of first voice tag state sᵢ, the combining result is used as Gaussian mixtures (M+1) of new state φi. At this time, probability of feature x conditioned on the new state is:

$$p ( x \vert {ϕ}_{i} ) = {χ}_{1} N ( {μ}_{{θ}_{i}} , {Σ}_{{θ}_{i}} ) + {\sum }_{m = 1}^{M} {χ}_{1 + m} N ( {μ}_{{s}_{im}} , {Σ}_{{s}_{im}} ) \qquad ( 11 )$$

Wherein

$${\sum }_{n = 1}^{1 + M} {χ}_{n} = 1 ,$$

μₛ_{ᵢₘ} is mean value of m-th Gaussian distribution of state sᵢ, Σₛ_{ᵢₘ} is variance of m-th Gaussian distribution of state sᵢ.

In the embodiment of the invention, combination of voice tags constructed based on HMM and template has the following advantages:

(1) Advantages of original HMM voice tag and template voice tag are integrated such that new voice tag can better describe time correlation of registration speech and improve its stability.

(2) As to GMM template tag, its Gaussian mixtures come from HMM acoustic model, and thus it doesn't increase storage space and computation time significantly as compared with voice tag method based on HMM.

(3) Since new voice tag can still be expressed by HMM, the method of the embodiment of the invention can still be applied into decoder based on HMM acoustic model without adding storage space and computation quantity obviously, which make it easy to apply this method into any voice tag system based on HMM.

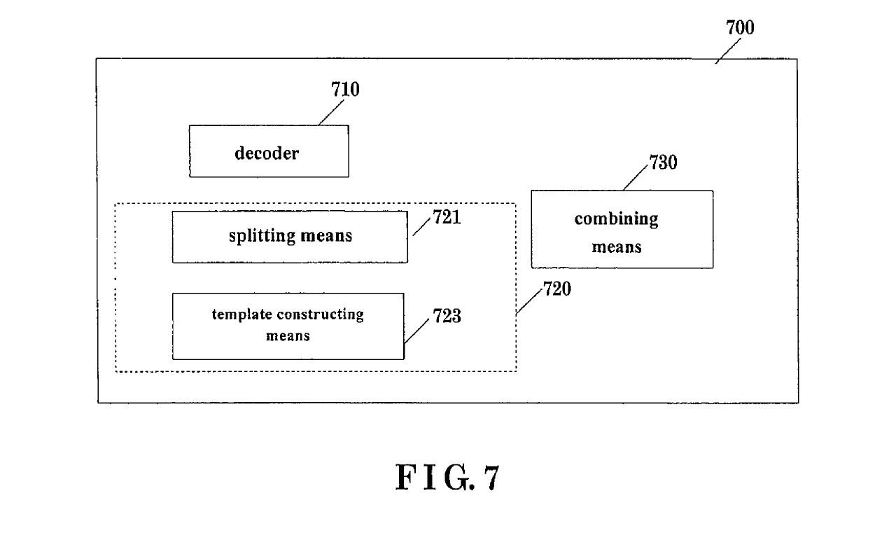

In the same inventive concept, FIG. 7 is block diagram of an apparatus for creating registration voice tag according to the embodiment of the invention. Then, this embodiment will be described with reference to this drawing. For those parts similar with the above embodiments, their description will be omitted.

As shown in FIG. 7, an apparatus 700 for creating voice tag may comprise: decoder 710 for recognizing input speech based on HMM and recognition network to construct a first voice tag; template extracting means 720 for extracting speech template for the speech to construct a second voice tag; and combining means 730 for combining the first voice tag and the second voice tag to construct voice tag of the registration speech.

In the embodiment of the invention, decoder 710 may perform the operation of constructing a first voice tag, template extracting means 720 may perform the operation of constructing a second voice tag, combining means 730 may perform the operation of combining the constructed first voice tag and the second voice tag to construct final voice tag of the registration speech, the content of which is with reference to the above and will be omitted for brevity.

In the embodiment of the invention, the template extracting means 720 may further comprise: splitting means 721 for splitting the speech in time based on state of the first voice tag; template constructing means 723 for extracting template for the speech in each of state periods based on the template matching to combine into template sequence as the second voice tag.

In the embodiment of the invention, the template constructing means 723 may be further configured to: obtain multiple Gaussian mixtures which are closest to speech mean feature in the state period from the Hidden Markov acoustic model; and combine the multiple Gaussian mixtures to construct Gaussian mixture model as template of speech in the state period in the registration speech.

Alternatively, in the embodiment of the invention, the template constructing means 723 may be further configured to: construct one Gaussian distribution by using speech mean feature in state period as mean value and setting unit matrix as variance matrix (as well as other suitable method of setting variance), and using the Gaussian distribution as template of speech in the state period in the registration speech.

In the embodiment of the invention, the combining means 730 may be further configured to: take union set of Gaussian mixtures contained in template of the state period and Gaussian mixtures contained in the state of the first voice tag as Gaussian mixtures contained in the new states, and combining each new state as voice tag of the speech.

Alternatively, the combining means 730 may be further configured to: merge Gaussian mixtures of the template of the state period into one Gaussian mixture; and combine the Gaussian mixture and Gaussian mixtures of states associated with the first voice tag as Gaussian mixtures contained in the new states, and combining each new state as voice tag of the speech.

The apparatus 700 and its various constituent parts for creating voice tag in the embodiment may be composed of dedicated circuit or chip and may also be implemented by computer (processor) executing corresponding program. Further, the apparatus 700 for creating voice tag in the embodiment can achieve the method of combining first and second voice tag constructed based on HMM and template matching to construct voice tag as described in conjunction with above FIGS. 1-6.

Those skilled in the art can appreciate that, the above methods and apparatuses may be implemented by using computer executable instructions and/or including into processor control codes, which is provided on carrier media such as disk, CD, or DVD-ROM, programmable memory such as read only memory (firmware) or data carrier such optical or electronic signal carrier. The method and apparatus of the embodiment may also be implemented by semiconductor such as super large integrated circuit or gate array, such as logic chip, transistor, or hardware circuit of programmable hardware device such as field programmable gate array, programmable logic device and so on, and may also be implemented by a combination of the above hardware circuit and software.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for creating voice tag, comprising:
constructing a first voice tag for registration speech based on Hidden Markov acoustic model, wherein the first voice tag is associated with specific state;
constructing a second voice tag for the registration speech based on template matching; and
combining the first voice tag and the second voice tag to construct voice tag of the registration speech. 10

2. The method according to claim 1, wherein the step of constructing the second voice tag further comprises:
splitting the registration speech in time based on state associated with the first voice tag;
extracting template for speech in each state period to combine into template sequence as the second voice tag.

3. The method according to claim 2, wherein the step of extracting template further comprises:
obtaining multiple Gaussian mixtures which are closest to speech mean feature in the state period from the Hidden Markov acoustic model; and
combining the multiple Gaussian mixtures to construct Gaussian mixture model as template of speech in the state period in the registration speech.

4. The method according to claim 1, wherein the step of combining the first voice tag and the second voice tag further comprises:
combining state associated with the first voice tag and template of the state period corresponding to the state to construct new states; and
combining the new states to form voice tag of the registration speech.

5. The method according to claim 4, wherein the step of combining state associated with the first voice tag and template of the state period corresponding to the state to construct new states further comprises:
taking union set of Gaussian mixtures contained in template of the state period and Gaussian mixtures contained in the state of the first voice tag as Gaussian mixtures contained in the new states.

6. The method according to claim 4, wherein the step of combining state associated with the first voice tag and template of the state period corresponding to the state to construct new states further comprises:
merging Gaussian mixtures of the template of the state period into one Gaussian mixture; and
combining the Gaussian mixture and Gaussian mixtures of states of the first voice tag as Gaussian mixtures contained in the new states.

7. The method according to claim 1, wherein transfer probability among states in speech unit contained in the voice tag may be the same as transfer probability among states in speech unit contained in the first voice tag.

8. The method according to claim 2, wherein transfer probability among states in speech unit contained in the voice tag may be the same as transfer probability among states in speech unit contained in the first voice tag.

9. The method according to claim 3, wherein transfer probability among states in speech unit contained in the voice tag may be the same as transfer probability among states in speech unit contained in the first voice tag.

10. The method according to claim 4, wherein transfer probability among states in speech unit contained in the voice tag may be the same as transfer probability among states in speech unit contained in the first voice tag.

11. The method according to claim 5, wherein transfer probability among states in speech unit contained in the voice tag may be the same as transfer probability among states in speech unit contained in the first voice tag.

12. The method according to claim 6, wherein transfer probability among states in speech unit contained in the voice tag may be the same as transfer probability among states in speech unit contained in the first voice tag.

13. An apparatus for creating voice tag, comprising:
decoder for recognizing input speech based on HMM and recognition network to construct a first voice tag, wherein the first voice tag is associated with specific state;
template extracting means for extracting speech template for the speech to construct a second voice tag; and
combining means for combining the first voice tag and the second voice tag to construct voice tag of the registration speech.

14. The apparatus according to claim 13, wherein the template extracting means further comprises:
splitting means for splitting the speech in time based on state of the first voice tag;
template constructing means for extracting template for speech in each state period to combine into template sequence as the second voice tag.

15. A system for creating voice tag, comprising:
means for constructing a first voice tag for registration speech based on Hidden Markov acoustic model, wherein the first voice tag is associated with specific state;
means for constructing a second voice tag for the registration speech based on template matching; and
means for combining the first voice tag and the second voice tag to construct voice tag of the registration speech.
